(19) United States
(12) Patent Application Publication
(10) Pub. No.: US 2023/0170197 A1
(43) Pub. Date: Jun. 1, 2023

(54) Inductively coupled plasma source mass spectrometry for silicon measurement

(71) Applicant: COMMISSARIA À L'ÉNERGIE ATOMIQUE ET AUX ÉNERGIES ALTERNATIVES, Paris (FR)

(72) Inventors: Isabelle Isnard, Antony (FR); Marta Garcia-Cortes, Paris (FR)

(21) Appl. No.: 18/059,107

(22) Filed: Nov. 28, 2022

(30) Foreign Application Priority Data
Nov. 29, 2021 (FR) 2112664

(51) Int. Cl. H01J 49/00; H01J 49/10

(52) U.S. Cl. CPC H01J 49/005; H01J 49/0027; H01J 49/105

(57) ABSTRACT

A method for measuring a sample comprising silicon by mass spectrometry is implemented from an inductively coupled plasma-tandem mass spectrometer, or ICP-MS/MS. The measurement method comprises a step of measuring by mass spectrometry by a reactive gas. The reactive gas comprising nitrous oxide.

### CROSS-REFERENCE TO RELATED APPLICATIONS

This application claims priority from French Patent Application No. 2112664 filed on Nov. 29, 2021. The content of this application is incorporated herein by reference in its entirety.

### TECHNICAL FIELD

The invention relates to the field of inductively coupled plasma source mass spectrometry measurement, better known by its acronym ICP-MS.

Thus, the invention more specifically relates to a mass spectrometry measurement method and a use of nitrous oxide N₂O in the context of such a mass spectrometry measurement.

### STATE OF THE PRIOR ART

The inductively coupled plasma source mass spectrometry measurements, hereinafter ICP-MS, and in particular when it comes to measuring silicon isotopes, can be disturbed by the presence of isobaric interferences. Indeed, silicon comprises three isotopes: the Si-28 isotope ²⁸Si, the Si-29 isotope ²⁹Si and the Si-30 isotope ³⁰Si for which a large number of interferences are observed, presented in the following table:

TABLE 1

| | |
|---|---|
| Si isotopes | Interferences |
| ²⁸Si⁺ | ¹⁴N¹⁴N⁺; ¹²C¹⁶O⁺ |
| ²⁹Si⁺ | ¹⁴N¹⁴N¹H⁺; ¹⁴N¹⁵N⁺; ²⁸Si¹H⁺; ¹³C¹⁶O⁺; ¹²C¹⁶O¹H⁺; ¹²C¹⁷O⁺ |
| ³⁰Si⁺ | ¹⁴N¹⁶O⁺; ¹⁴N¹⁵N¹H⁺; ¹³C¹⁷O⁺; ¹²C¹⁷O¹H⁺; ¹⁵N¹⁵N⁺; |

Due to these interferences, obtaining a measurement of silicon and these isotopes by ICP-MS with a good accuracy is made particularly difficult. However, for certain applications, in particular related to the semiconductor industry, such a measurement is required. It will be noted that these needs are in particular present for the samples with a high enrichment in the silicon-28 isotope ²⁸Si of silicon where, in addition, a high sensitivity is required to be able to detect the minority isotopes of silicon in order to quantify the enrichment.

In order to obtain such an accuracy, the use of multi-collector inductively coupled plasma source mass spectrometry has been proposed [1, 2]. This technique, if it allows solving the problem of the interferents, remains complicated to implement and is expensive.

As a result, there could be an interest in developing a simpler inductively coupled plasma source mass spectrometry technique, such as the quadrupole inductively coupled plasma source mass spectrometry, better known under the acronym ICP-QMS, or inductively coupled plasma-tandem mass spectrometry, better known under the acronym ICP-MS/MS, in order to allow a measurement of silicon and the isotopes thereof which is compatible with the samples with a high enrichment in the silicon-28 isotope ²⁸Si of silicon. Nevertheless, the attempts [2, 3, 4, 5] carried out with these techniques, generally based on the use of oxygen [4, 5] as a reactive gas, do not allow obtaining an adapted sensitivity.

### DISCLOSURE OF THE INVENTION

The aim of the invention is thus to provide an inductively coupled plasma source mass spectrometry measurement method which is suitable for the samples with a high enrichment in the silicon-28 isotope ²⁸Si of silicon and which is simpler to implement than the multi-collector inductively coupled plasma source mass spectrometry.

The invention relates for this purpose to a method for measuring a sample comprising silicon by mass spectrometry, said method being implemented from an inductively coupled plasma-tandem mass spectrometer, or ICP-MS/MS, said measurement method comprising a step of measuring by mass spectrometry by means of a reactive gas, the method being characterised in that the reactive gas comprises nitrous oxide.

The inventors have discovered that nitrous oxide N₂O as a reactive gas has a reactivity which is significantly higher than dioxygen which is generally used as a reactive gas in the prior art for such measurements. As a result, when using nitrous oxide N₂O as a reactive gas in the ICP-MS/MS measurement framework, a sensitivity which is significantly greater than that obtained with dioxygen results therefrom. Thus such a method, as shown by the inventors and as described below, allows obtaining an accuracy in the measurement of the molar proportion of the silicon-28 isotope relative to all silicon atoms which is less than 0.01%.

The reactive gas can consist of nitrous oxide.

The measurement step can allow determining a value relating to the amount of a silicon-28 isotope.

It will be noted that in a usual configuration of the invention, the measurement can also allow obtaining a value relating to the amounts of the silicon-28 and silicon-29 isotopes.

The value relating to the amount of the silicon-28 isotope can be a molar proportion of the silicon-28 isotope relative to all silicon atoms.

Such a value allows estimating the enrichment of the sample in the silicon-28 isotope. This value is particularly relevant in the context of certain applications such as those in the semiconductor industry.

The sample may have a molar proportion of the silicon-28 isotope relative to all silicon atoms which is greater than 99%.

The method according to the invention is particularly adapted for such samples since it allows, as shown later in this document, obtaining a sensitivity which is compatible with such proportions of the silicon-28 isotope.

During the mass spectrometric measurement step, the reactive gas is introduced into a reaction cell of the mass spectrometer at a flow rate comprised between 0.03 and 0.28 mL.min⁻ ¹ and preferably comprised between 0.06 and

0.15 mL.min⁻¹.

The inventors have discovered that with such a flow rate, the sensitivity to silicon isotopes is maximised.

The invention further relates to a use of a reactive gas comprising nitrous oxide for a mass spectrometric measurement of a sample comprising silicon from an inductively coupled plasma-tandem mass spectrometer, or ICP-MS/MS.

The reactive gas may consist of nitrous oxide.

The sample may have a molar proportion of the silicon-28 isotope relative to all silicon atoms which is greater than 99%.

As demonstrated later in this document, such a use is particularly advantageous since it enables obtaining a particularly significant sensitivity to the silicon isotopes relative to the prior art.

### BRIEF DESCRIPTION OF THE DRAWINGS

The present invention will be better understood on reading the description of exemplary embodiments, given for purely illustrative and non-limiting purposes, with reference to the appended drawings in which:

FIG. 1 schematically illustrates the different stages of a mass spectrometer as used in the scope of implementation of the invention;

FIG. 2A graphically illustrates the reactivity profile for the silicon-28 isotope depending on the dioxygen flow rate introduced into a reaction cell of the spectrometer as a reactive gas for a reference silicon sample;

FIG. 2B graphically illustrates the reactivity profile for the silicon-28 isotope depending on the nitrous oxide flow rate introduced into the reaction cell of the spectrometer as a reactive gas for this same reference silicon sample;

FIG. 3 graphically illustrates the sensitivity obtained for dioxygen and nitrous oxide, respectively, for the different silicon isotopes;

Identical, similar or equivalent portions of the different figures bear the same reference numerals so as to facilitate the passage from one figure to the other.

The different portions represented in the figures are not necessarily represented according to a uniform scale, to make the figures more readable.

The different possibilities (variants and embodiments) should be understood as not being mutually exclusive and can be combined with each other.

### DESCRIPTION OF EMBODIMENTS

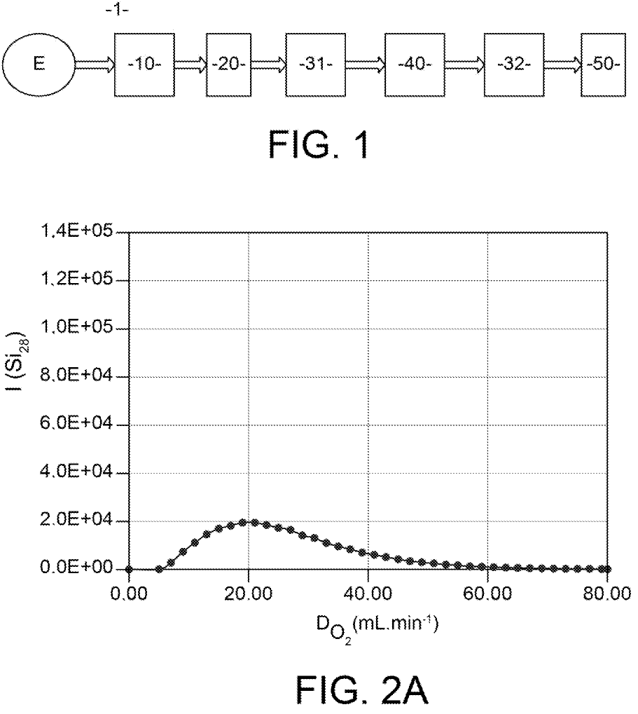

As described below in connection with FIG. 1, the inventors have discovered that the inductively coupled plasma-tandem mass spectrometer 1, or ICP-MS/MS when it is implemented with nitrous oxide as a reactive gas, allows obtaining a measurement of a sample comprising silicon with an improved sensitivity relative to measurements obtained according to the prior art.

As a reminder, an inductively coupled plasma-tandem mass spectrometer 1 comprises, as illustrated in FIG. 1 the following elements:
a plasma generator system 10 capable of atomising and ionising the species of the sample E into a plasma,
ion optics 20 in order to focus the ions created during the ionisation of the atoms of the sample,
a first electromagnetic filter 31, such as a quadrupole analyser, in order to carry out a first filtering among the ions of the plasma after these have been focused by the ion optics 20, the first filter allowing selecting the ions corresponding to the target atom and the interferents thereof,
a reaction cell 40 in order to cause the ions selected during the filtering performed by the first quadrupole filter 30 to react with a reactive gas and thus produce ionised molecules which form part of the product molecules formed by reaction of the target atom or molecule ionised with the reactive gas,
a second electromagnetic filter 32, such as a quadrupole analyser, in order to carry out a second filtering from the ionised molecules, the second filter allowing selecting only the product molecules, which therefore comprise the target atom, formed in the reaction cell,
a detector capable of intercepting the product molecules after the second filtering carried out by the second filter and providing a signal relating to said interceptions.

It will be noted that the term “the target atom or molecule” means, herein, and in the rest of this document, the isotope or the molecule comprising the isotope which is the target of the measurement by spectrometry, that is to say which is the object of the quantification in the sample to be measured. In the present example concerning the silicon isotopes, said target atom corresponds in turn to each of the silicon isotopes as described below in connection with FIG. 3.

Similarly, as indicated above, the term “product molecule” means herein and in the rest of this document, the product molecule obtained during the reaction between the ionised target atom or molecule and the reactive gas. Within the scope of the present invention, namely the measurement of the natural silicon isotopes ²⁸Si, ²⁹Si and ³⁰Si by the use of nitrous oxide N₂O, the product molecules are respectively ²⁸SiO₂⁺, ²⁹SiO₂⁺ and ³⁰SiO₂⁺. It should be noted that for the use of dioxygen O₂, the product molecules are identical.

During the implementation of a mass spectrometric measurement with an ICP-MS/MS mass spectrometer, the choice of a reactive gas must be adapted to the atoms which will be targeted for the measurement. Thus in the context of silicon isotopes, the reactive gases [2, 3, 4, 5] used in the prior art, whether in the context of ICP-MS/MS mass spectrometry measurement or ICP-QMS mass spectrometry measurement, comprise either ammonia NH₃, or methane CH₄, or dioxygen O₂. More specifically, concerning the ICP-MS/MS mass spectrometry [4, 5], it is dioxygen O₂ which is generally used for the reactive gas. As a result, in this document, the inventors have chosen to compare the results obtained within the scope of the invention, that is to say when the reactive gas is based on nitrous oxide N₂O, with those obtained for a reactive gas based on dioxygen O₂.

The inventors have discovered, based on the reaction enthalpy calculation (known under the reference ΔHᵣ), that the reaction of the silicon cations Si+ with nitrous oxide N₂O is significantly exothermic whereas the reaction of silicon cations Si⁺ with dioxygen O₂ is endothermic. As a result, the inventors have estimated that the use of a reactive gas based on nitrous oxide N₂O should allow obtaining an optimised reactivity and therefore obtaining an ICP-MS/MS mass spectrometry measurement which is particularly sensitive.

Indeed, here, in parallel with the reaction enthalpy calculated for the latter, are the reactions likely to be obtained for the silicon isotopes in cationic form in the reaction cell 40 with respectively dioxygen and nitrous oxide N₂O:

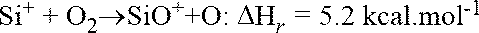

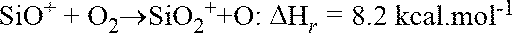

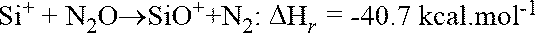

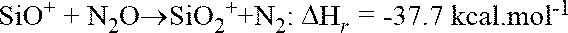

The reactions with nitrous oxide are therefore favourable and must have a particularly significant yield relative to the reactions with dioxygen. As a result, the inventors have considered that nitrous oxide should allow, in the context of measurement of silicon and the different isotopes thereof by ICP-MS/MS mass spectrometry, reaching a significantly improved sensitivity relative to that obtained with dioxygen.

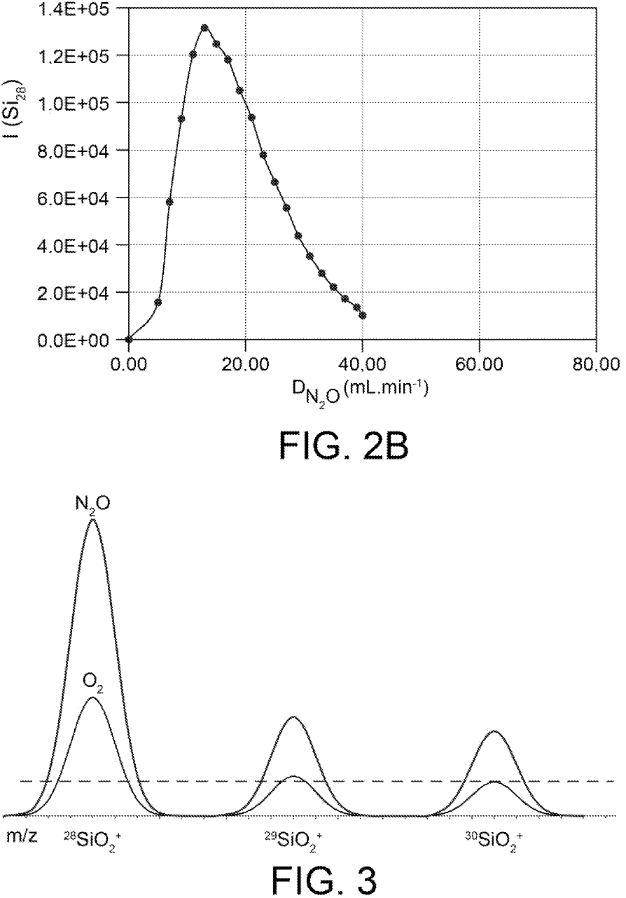

In order to verify this, the inventors carried out sensitivity measurements in ICP-MS/MS mass spectrometry from the same silicon sample as a source of silicon-28 isotope ²⁸Si for respectively reactive gases based on dioxygen (oxygen flow rate D_{O2} comprised between 0 and 0.78 mL.min⁻¹), corresponding to the measurements of the prior art, and for reactive gases based on nitrous oxide (nitrous oxide flow rate D_{N2O} comprised between 0 and 0.28 mL.min⁻¹). FIG. 2A shows the intensity I(Si²⁸) of the signal in counts per second obtained for this sample from reactive gas based on dioxygen O₂, this depending on the dioxygen flow rate D_{O2}. It can be seen on this graph that the maximum is obtained about the 0.19 mL.min⁻¹ of dioxygen for which about 20,000 counts are obtained.

FIG. 2B shows the intensity of the signal in counts per second obtained for this sample from reactive gas based on nitrous oxide N₂O this depending on the nitrous oxide flow rate D_{N2O}. It is considered that for nitrous oxide, the maximum is obtained around 0.09 mL.min⁻¹ of nitrous oxide for which approximately 132,000 counts are obtained, i.e. more than 6 times the value obtained from dioxygen. It should also be noted that this maximum is obtained for a nitrous oxide N₂O flow rate which is less than that of dioxygen O₂, confirming that nitrous oxide N₂O has a reaction efficiency which is more significant than that of dioxygen O₂.

Thus, within the scope of the invention, the reactive gas flow rate used for the mass spectrometric measurement is advantageously comprised between 0.03 and 0.28 mL.min⁻¹ and preferably between 0.06 and 0.15 mL.min⁻¹.

Based on this study, the inventors were able to optimise the instrumental parameters in order to maximise the sensitivity for the silicon isotopes ²⁸Si, ²⁹Si and ³⁰Si for the reactive gases based on dioxygen O₂ and based on nitrous oxide N₂O and to estimate the sensitivity and the background equivalent concentration, better known by its acronym BEC. These results are summarised in the following table.

It will be noted that the present document does not describe such a parameter optimisation. This optimisation is indeed part of the usual practice of the person skilled in the art and being dependent on the apparatus used for the mass spectrometry measurement. The description of such an optimisation therefore has no interest in the present document.

TABLE 2

| Reactive gas | N₂O | O₂ |
|---|---|---|
| Sensitivity ²⁸SiO₂ (counts ppb-1) | 4.0.10³ | 4.0.10² |
| BEC (ppb Si) | 2 | 3 |

It can be seen that nitrous oxide N₂O allows achieving a sensitivity which is almost 10 times greater than that of dioxygen O₂, with a signal to noise ratio reduced by 50%. With a reactive gas based on nitrous oxide N₂O, the inventors have therefore estimated being able to carry out measurements on samples comprising a high proportion in a silicon isotope with an optimised sensitivity. FIG. 3 shows that this improved sensitivity obtained within the framework of such a measurement method applies both for the majority silicon Si isotope, which is the Si-28 isotope ²⁸Si, and for the minority silicon Si isotopes which are the Si-29 isotope ²⁹Si and Si-30 isotope ³⁰Si.

In order to demonstrate this, the inventors have performed 3 campaigns (indicated as session) of 6 ICP-MS/MS mass spectrometry measurements from a reactive gas based on nitrous oxide N₂O from a silicon sample showing an enrichment in the silicon-28 isotope ²⁸Si. The results of these measurement campaigns are summarised in the following table with, for each of the measurements, an estimate of the proportion of the silicon-28 isotope ²⁸Si (%mol ²⁸Si) and the estimated uncertainty U with a coverage factor k equal to 2 (such a coverage factor corresponds to a confidence level of 95%). On the “mean” and “standard deviation” lines, the mean and the standard deviation obtained for each of the campaigns (therefore encompassing the 6 measurements) and, for the global column, obtained for all of these measurements, are shown respectively.

TABLE 3

| | Session 1 | | Session 2 | | Session 3 | | Global |
|---|---|---|---|---|---|---|---|
| Replica | %mol ²⁸Si | U(k=2) | %mol ²⁸Si | U(k=2) | %mol ²⁸Si | U(k=2) | |
| 1 | 99.836 | 0.002 | 99.843 | 0.003 | 99.841 | 0.003 | |
| 2 | 99.839 | 0.003 | 99.844 | 0.003 | 99.842 | 0.003 | |
| 3 | 99.840 | 0.002 | 99.843 | 0.004 | 99.842 | 0.003 | |
| 4 | 99.841 | 0.003 | 99.844 | 0.003 | 99.843 | 0.003 | |
| 5 | 99.842 | 0.002 | 99.844 | 0.003 | 99.842 | 0.003 | |
| 6 | 99.842 | 0.003 | 99.845 | 0.003 | 99.841 | 0.003 | |
| average | 99.840 | | 99.844 | | 99.842 | | 99.842 |
| standard deviation | 0.0024 | | 0.0008 | | 0.0007 | | 0.002 |

It can be seen that the values measured during these different campaigns and these different measurements do not differ significantly and that the standard deviation is less than 0.004%. The method according to the invention therefore allows obtaining a measurement which is more sensitive than those of the prior art and is perfectly adapted for the measurement of samples with a high enrichment in the silicon-28 isotope ²⁸Si.

It will be noted that the present description, if it is focused on the method, of course also covers the use of a reactive gas comprising nitrous oxide in the context of mass spectrometric measurements of samples comprising silicon.

### BIBLIOGRAPHIC REFERENCES

[1] P. Becker (2003) “Metrologia” volume 40 number 6 pages 366 to 375
[2] A. Pramann et al. (2011) “International Journal of Mass Spectrometry” volume 299 number 2-3 pages 78-86, 2011
[3] H.T. Liu et al. (2003) “Spectrochimica Acta Part B: Atomic Spectroscopy” volume 58, number 1, pages 153-157,
[4] F. Aureli et al. (2012) “Journal of Analytical Spectroscopy” volume 27, pages 1540-1548
[5] A. Virgilio et al. (2016) “Spectrochimica Acta Part B: Atomic Spectroscopy” Volume 116 pages 31-36

1. A method for measuring a sample comprising silicon by mass spectrometry, the method being implemented from an inductively coupled plasma-tandem mass spectrometer, or ICP-MS/MS,
the method comprising a step of measuring by mass spectrometry by means of a reactive gas, wherein the reactive gas comprises nitrous oxide.

2. The method according to claim 1, wherein the reactive gas consists of nitrous oxide.

3. The method according to claim 1, wherein the mass spectrometric measurement step allows determining a value relating to an amount of a silicon-28 isotope.

4. The method according to claim 3, wherein the value relating to an amount of the silicon-28 isotope is a molar proportion of the silicon-28 isotope relative to all silicon atoms.

5. The method according to claim 1, wherein the sample has a molar proportion of the silicon-28 isotope relative to all silicon atoms which is greater than 99%.

6. The method according to claim 1, wherein during the mass spectrometric measurement step, the reactive gas is introduced into a reaction cell of the mass spectrometer at a flow rate comprised between 0.03 and 0.28 mL.min⁻¹ and preferably comprised between 0.06 and 0.15 mL.min⁻¹.

7. A use of a reactive gas comprising nitrous oxide for a mass spectrometric measurement of a sample comprising silicon from an inductively coupled plasma-tandem mass spectrometer, or ICP-MS/MS.

8. The use of a reactive gas according to claim 7, wherein the reactive gas consists of nitrous oxide.

9. The use of a reactive gas according to claim 7, wherein the sample has a molar proportion of the silicon-28 isotope relative to all silicon atoms which is greater than 99%.

10. The use of a reactive gas according to claim 8, wherein the sample has a molar proportion of the silicon-28 isotope relative to all silicon atoms which is greater than 99%.
